(19) United States
(12) Patent Application Publication
(10) Pub. No.: US 2024/0111253 A1
(43) Pub. Date: Apr. 4, 2024

(54) ELECTRONIC DEVICE HAVING AN ENCLOSURE WITH A CERAMIC-REINFORCED COMPOSITE COMPONENT

(71) Applicant: Apple Inc., Cupertino, CA (US)

(72) Inventors: Que Anh S. Nguyen, San Jose, CA (US); Andi M. Limarga, Cupertino, CA (US); Weidi Zhu, Milpitas, CA (US)

(21) Appl. No.: 18/239,671

(22) Filed: Aug. 29, 2023

Related U.S. Application Data
(60) Provisional application No. 63/409,106, filed on Sep. 22, 2022.

(51) Int. Cl. G04G 17/08; B82Y 30/00; G04G 19/00; G04G 21/04

(52) U.S. Cl. CPC G04G 17/08; B82Y 30/00; G04G 19/00; G04G 21/04; G04G 21/025

(57) ABSTRACT

A composite enclosure component for an electronic device is disclosed. The composite enclosure component is formed at least in part from a composite material that includes a porous ceramic structure at least partially embedded in a glass-based matrix. The glass-based matrix includes one or more sets of nanoparticles that impart a color to the composite enclosure component.

### CROSS-REFERENCE TO RELATED APPLICATION(S)

This application is a nonprovisional application of and claims the benefit of U.S. Provisional Patent Application No. 63/409,106, filed Sep. 22, 2022, and titled “Electronic Device Having an Enclosure with a Ceramic-Reinforced Composite Component,” the disclosure of which is hereby incorporated herein by reference in its entirety.

### FIELD

The described embodiments relate generally to electronic devices that include a composite component. More particularly, the present embodiments relate to an electronic device having a ceramic-reinforced composite enclosure component that includes a porous ceramic structure in a glass-based matrix.

### BACKGROUND

Some modern day portable electronic devices may include a wireless communication system and/or a wireless charging system. Typically, such wireless communication and/or charging systems are positioned within the enclosure of the electronic device. Embodiments described herein are directed to electronic devices that include ceramic-reinforced composite enclosure components that include a porous ceramic structure. The composite enclosure components described herein may have advantages as compared to some traditional electronic device enclosures.

### SUMMARY

The present embodiments relate to a composite enclosure component for an electronic device. The composite enclosure component may be a composite housing component that defines at least a portion of side and rear surfaces of the electronic device. The composite enclosure component is formed at least in part from a composite material and may include at least one coloring agent. Electronic devices and enclosures including the composite enclosure component are also within the scope of this disclosure.

In some embodiments, the composite material includes a porous ceramic structure at least partially embedded in a glass-based matrix. For example, the glass-based matrix may comprise a glass material and a set of nanoparticles embedded in the glass material. In some instances, the nanoparticles are metallic nanoparticles configured to impart a color to the glass-based matrix. The porous ceramic structure may reinforce the composite material and may have three-dimensional (3-D) network structure. Such a porous ceramic structure may define a ceramic network.

The composite enclosure components described herein may have both particular electromagnetic properties and impact resistance. For example, all or part of the enclosure component may be configured to have dielectric properties suitable for use over a component of a wireless communication system. In addition, all or part of the enclosure component may be configured to have properties suitable for use over a component of a wireless charging system. Furthermore, the composite enclosure components described herein may have particular optical properties such as a color value, a transmission value, an absorption value, or a refractive index. The transmission value may be measured over a visible wavelength range or an infrared (IR) wavelength range.

In embodiments, the composite materials described herein provide a balance between two or more of optical properties, electromagnetic properties, and mechanical properties. For example, a composite material including a ceramic structure at least partially embedded in a glass-based matrix material may have an enhanced toughness as compared to an enclosure formed solely of the glass-based matrix material. However, inclusion of the ceramic structure and/or inclusion of metallic nanoparticles in the composite material can tend to increase the dielectric constant of the composite material. Therefore, in some embodiments the composite materials described herein can provide a balance between toughness and dielectric properties in order to obtain a composite enclosure component that is acceptable for use with internal components of a wireless communication and/or charging system.

The disclosure provides a portable electronic device, comprising a touch-sensitive display and an enclosure at least partially surrounding the touch-sensitive display and comprising a front cover assembly positioned over the touch-sensitive display and a housing assembly coupled to the front cover assembly, the housing assembly including an enclosure component formed from a composite material comprising a ceramic lattice structure defining a pore network, a matrix formed from a glass material and at least partially filling pores of the pore network, and a set of metallic nanoparticles embedded in the glass material.

The disclosure also provides an electronic watch comprising a display, a rear-facing sensing array, and an enclosure comprising a composite housing component defining a side surface and a portion of a rear surface of the electronic watch and a front cover assembly coupled to the composite housing component and positioned over the display. The composite housing component comprises a ceramic network defining a plurality of pores, a glass material extending into at least some of the plurality of pores and defining at least a portion of an exterior surface of the enclosure, and a set of metallic nanoparticles within the glass material.

The disclosure further provides a portable electronic device comprising an enclosure at least partially defining an internal cavity of the portable electronic device, the enclosure comprising a first enclosure component including a composite material comprising a porous ceramic structure defining surface pores along an exterior surface of the portable electronic device, a glass material filling the surface pores of the porous ceramic structure, and a set of metallic nanoparticles embedded within the glass material and having a concentration that varies along a thickness direction of the first enclosure component, and a second enclosure component coupled to the first enclosure component.

### BRIEF DESCRIPTION OF THE DRAWINGS

The disclosure will be readily understood by the following detailed description in conjunction with the accompanying drawings, wherein like reference numerals designate like elements.

FIG. 1A shows a front view of an electronic device.

FIG. 1B shows a rear view of the electronic device of FIG. 1A.

FIG. 2 shows a cross-section view of an electronic device.

FIG. 3 shows another cross-section view of an electronic device.

FIG. 4 shows an enlarged view of an enclosure component of an electronic device.

FIG. 5 shows a cross-section view of an enclosure component.

FIG. 6 shows a cross-section view of another enclosure component.

FIG. 7 shows a cross-section view of another enclosure component.

FIG. 8 shows a magnified cross-section view of an enclosure component.

FIG. 9 shows a magnified cross-section view of another enclosure component.

FIG. 10 shows a magnified cross-section view of another enclosure component.

FIG. 11 shows a magnified cross-section view of another enclosure component.

FIG. 12 shows a magnified cross-section view of another enclosure component.

FIG. 13 shows a view of another enclosure component.

FIG. 14 shows a view of an electronic device including another enclosure component.

FIG. 15 shows a block diagram of a sample electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The present embodiments relate to a composite enclosure component for an electronic device. The composite enclosure component may be a composite housing component that defines at least a portion of side and rear surfaces of the electronic device. The composite enclosure component is formed at least in part from a composite material and may include at least one coloring agent. Electronic devices and enclosures including the composite enclosure component are also within the scope of this disclosure.

In some embodiments, the composite material includes a porous ceramic structure at least partially embedded in a glass-based matrix. For example, the glass-based matrix may comprise a glass material and a set of nanoparticles embedded in the glass material. In some instances, the nanoparticles are metallic nanoparticles configured to impart a color to the glass-based matrix. The porous ceramic structure may reinforce the composite material and may have three-dimensional (3-D) network structure.

The composite enclosure components described herein may have both particular electromagnetic properties and impact resistance. For example, all or part of the enclosure component may be configured to have dielectric properties suitable for use over a component of a wireless communication system. In addition, all or part of the enclosure component may be configured to have properties suitable for use over a component of a wireless charging system. Furthermore, the composite enclosure components described herein may have particular optical properties such as a color value, a transmission value, an absorption value, or a refractive index. The transmission value may be measured over a visible wavelength range or an infrared (IR) wavelength range. In some cases, an optical property or electromagnetic property may be measured for a region of the glass-based matrix while in other cases the optical property or electromagnetic property may be measured over a region that includes both the glass-based matrix and the porous ceramic structure.

In embodiments, the composite materials described herein provide a balance between two or more of optical properties, electromagnetic properties, and mechanical properties. For example, a composite material including a ceramic structure at least partially embedded in a glass-based matrix material may have an enhanced toughness as compared to an enclosure formed solely of the glass-based matrix material. However, inclusion of the ceramic structure and/or inclusion of metallic nanoparticles in the composite material can tend to increase the dielectric constant of the composite material. Therefore, in some embodiments the composite materials described herein can provide a balance between toughness and dielectric properties in order to obtain a composite enclosure component that is acceptable for use with internal components of a wireless communication and/or charging system.

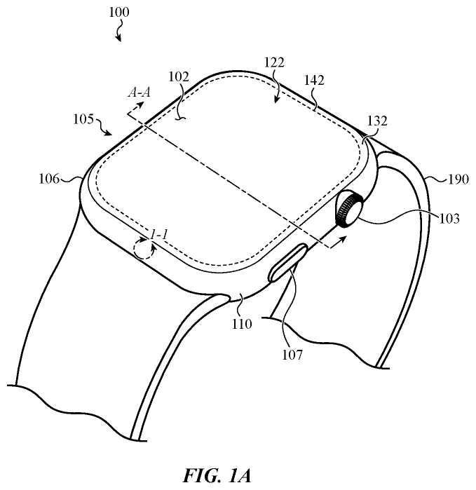

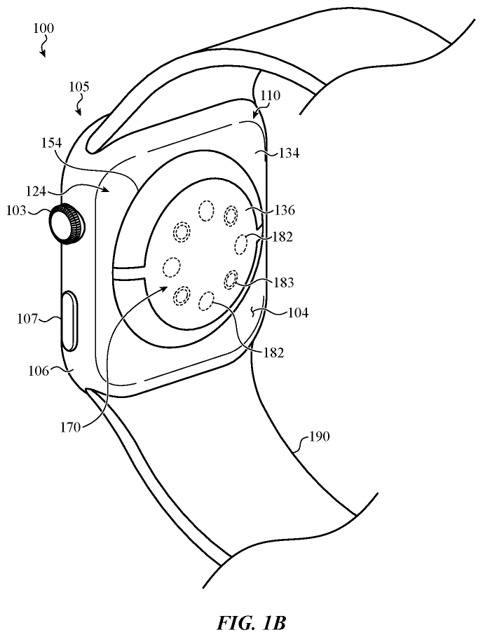

These and other embodiments are discussed below with reference to FIGS. 1A-15. However, those skilled in the art will readily appreciate that the detailed description given herein with respect to these figures is for explanatory purposes only and should not be construed as limiting.

FIG. 1A shows a front view of an electronic device. The electronic device 100 has an enclosure 105 that includes a composite enclosure component. The electronic device 100 may be a wearable electronic device, such as an electronic watch (e.g., a smartwatch) and/or an electronic heath monitoring device. In additional embodiments, the electronic device may be a mobile telephone (also referred to as a mobile phone), a notebook computing device (e.g., a notebook or laptop), a tablet computing device (e.g., a tablet), a portable media player, a smart speaker device, or another type of portable electronic device. The electronic device may also be a desktop computer system, a computer component, input device, appliance, or virtually any other type of electronic product or device component.

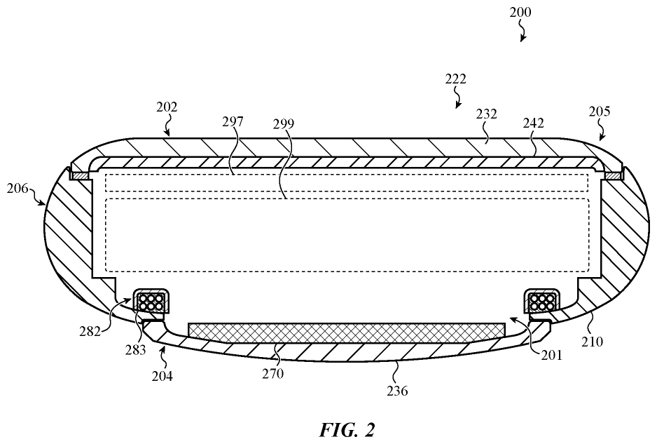

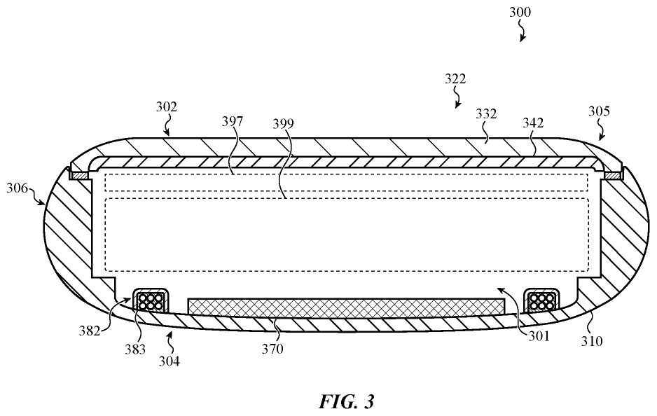

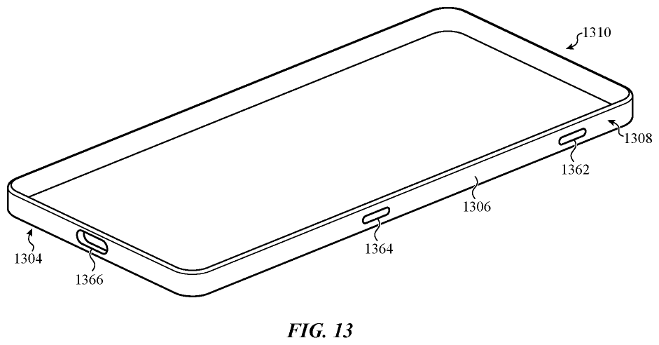

As shown in FIG. 1A, the electronic device includes an enclosure 105. The enclosure 105 includes a cover assembly 122 (a front cover assembly), a cover assembly 124 (a rear cover assembly, FIG. 1B), and an enclosure component 110. Internal components of the electronic device 100 may be at least partially enclosed by the cover assembly 122, the cover assembly 124, and the enclosure component 110. In some cases, these internal components may be positioned within an internal cavity defined by the enclosure 105, as shown in the cross-section views of FIGS. 2 and 3. In other embodiments, the electronic device need not include a rear cover assembly and the enclosure component may largely define the rear surface of the electronic device, as shown in the examples of FIGS. 3 and 13.

The enclosure 105 of FIGS. 1A and 1B includes a composite enclosure component as described herein. The composite enclosure component is formed at least in part from a composite material. In embodiments, the composite material comprises a porous ceramic that is least partially embedded in a matrix material. As described in more detail with respect to FIG. 4, the matrix material may be a glass-based matrix material that includes a set of nanoparticles. In some instances, the nanoparticles are metallic nanoparticles configured to impart a color to the glass-based matrix material.

In some cases, the composite enclosure component is configured to have an electromagnetic property suitable for use over an internal component of the electronic device. For example, the composite enclosure component may be configured to have dielectric properties suitable for use over a component of a wireless communication system. In some cases, the composite enclosure may have a dielectric constant from 3 to 15, from 4 to 10, from 3 to 7, 4 to 8, 4 to 6.5, 5 to 7, 5 to 6.5, 5.5 to 7.5, 5.5 to 7, or 6 to 7 in a radio frequency band. In some cases, these values are maximum values while in other cases these values are measured at the frequency range(s) of interest. As an example, the frequency range of interest may be from about 5 GHz to about 45 GHz, or from 25 GHz to 45 GHz. These values may be measured at room temperature.

As an additional example, the composite enclosure component may be configured for use over a component of a wireless charging system that is configured to receive wireless power from an external device or charge. As a further example, the composite material of the composite enclosure component may have a magnetic permeability sufficiently low that it does not interfere with transmission of magnetic fields generated by the inductive coupling wireless charging system. In some cases, the composite enclosure component may be substantially non-magnetic.

The enclosure component 110 may at least partially define the side surface 106 of the electronic device 100. In some cases, the side surface 106 may be curved, with the curve extending from the front cover assembly 122 to the rear cover assembly 124. The enclosure component 110 may define an opening to the cavity defined by the enclosure 105. The enclosure component 110 may also be referred to herein as a housing. The enclosure component 110 may be coupled to each of a front cover assembly 122 and a rear cover assembly 124 with an adhesive, a fastener, or a combination thereof. As illustrated in FIG. 1B, the composite enclosure component 110 is a unitary component formed from a single piece of material. In additional examples, a housing of the electronic device may be a housing assembly assembled from multiple enclosure components. As referred to herein, an enclosure component or member formed from a particular material may also include a relatively thin coating of a different material along one or more surfaces, such as an anodization layer, a physical vapor deposited coating, a paint coating, a primer coating (which may include a coupling agent), a smudge-resistant coating or the like.

As shown in FIG. 1A, the front cover assembly 122 at least partially defines a front surface 102 of the electronic device. In the example of FIG. 1A, the front cover assembly 122 defines a substantial entirety of the front surface 102 of the electronic device. In the example of FIG. 1A, the front cover assembly 122 includes a front cover member 132, also referred to herein simply as a front member. The front cover assembly 122 may also include an exterior coating such as an oleophobic coating and/or an anti-reflective coating, an interior coating, such as a coating that provides a visual effect (e.g., a decorative or masking coating), or a combination thereof.

The front cover member 132 may be substantially transparent or include one or more substantially transparent portions (alternately transparent windows) over the display assembly 142, an optical sensor, or the like. The front cover member 132 or its transparent window may be substantially transparent to light in the visible spectrum (e.g., 360 nm to 740 nm) and in some cases may also be transparent to at least some ranges of infrared light. For example, a transparent cover member or portion thereof may have an average transmission for visible light that is greater than or equal to 80%. In some cases, the front cover member 132 may be formed from a glass material, a glass ceramic material, or combinations thereof. In additional cases, the front cover member 132 may include at least one or more of a glass layer, a glass ceramic layer, or a polymer layer. In some cases, the thickness of the front cover member 132 may be 2 mm or less or 1 mm or less. For example, the thickness of the front cover may range from 300 micrometers to 1 mm or from 300 micrometers to 2 mm.

As shown in FIGS. 1A and 1B, a band 190 may be attached to the enclosure component 110 and configured to secure the wearable electronic device to a user. The electronic device 100 may further include a crown module that is positioned at least partially within an opening formed within the enclosure member. The crown module may include an input member 103 (e.g., a dial) having an outer surface configured to receive a rotary user input. The crown module may be offset with respect to a centerline of the enclosure component 110 (between the top and the bottom of the enclosure member). The offset may be toward the top of the enclosure component 110. The dial 103 may have a portion that is higher than an interface between the front cover assembly 122 and the enclosure component 110. As shown in FIGS. 1A and 1B, the electronic device 100 also includes the input member 107 (e.g., a button).

As shown in FIG. 1B, the electronic device 100 also includes a rear cover assembly 124 which at least partially defines a rear surface 104 of the electronic device. In some cases, the rear surface 104 of the electronic device 100 may be substantially flat while in other cases the rear surface 104 may define a convex outer contour that protrudes outward or toward a wrist of a user, when the electronic device 100 is worn. The rear cover assembly 124 may include one or more electrodes 154 positioned along the rear surface 104. In the present example, the electrode(s) 154 are positioned at a surface of the rear crystal 136, which may be a sapphire crystal. In some embodiments, the electrode(s) 154 may additionally or alternatively be positioned along a surface of the rear cover member 134. The electrode(s) 154 may contact the skin of a user wearing the device and may be operably coupled to a processor and/or sensing circuitry of the electronic device 100. The electrode(s) 154 may be configured to measure or detect a voltage or other electrical property of the skin of a user when the electronic device 100 is worn by the user and the electronic device 100 may be configured to determine one or more physiological parameters of the user including, but not limited to, a heart rate, an electrocardiogram (ECG or EKG), atrial fibrillation (afib) detection, electrodermal activity (EDA sensor), and other similar skin-based or tissue based bio-measurements. The rear cover assembly 124 may also include an exterior coating such as an oleophobic coating. The oleophobic coating may be applied to the rear cover member 134 in a similar fashion as previously described for the enclosure component 110.

In the example of FIG. 1B, the rear cover assembly 124 comprises a rear cover member 134. The rear cover member 134 may also be simply referred to herein as a rear member. The rear cover member 134 may partly define the rear surface 104 of the electronic device. In some cases, the rear cover member 134 may be integrally formed with the housing component and in other cases the rear cover member 134 may be coupled to the housing component 110. In some cases, the rear cover member 134 may be translucent or opaque to light in the visible spectrum. The rear cover assembly 124 comprises a rear crystal 136. The rear crystal 136 may also be referred to herein as a rear cover member 136. The rear crystal 136 may be positioned over at least a portion of a sensing array 170 of the electronic device 100. The rear crystal 136 may be substantially transparent to light in the visible spectrum and the infrared spectrum. In some cases, the rear crystal 136 may be formed from a ceramic material (e.g., sapphire or transparent zirconia), a glass ceramic material, a glass material, a polymer material, and/or a composite material. The rear crystal 136 may be coupled to the rear cover member 134 with an adhesive, a fastener, or a combination thereof.

In the example of FIG. 1B, the sensing array 170 includes four optical modules 182 and four optical modules 183. The optical modules (182, 183) may include at least one visible light optical module and at least one infrared light optical module. As described herein, the optical modules (182, 183) may be configured to allow the device 100 to measure one or more physiological characteristics or other bio-measurements of the user including, without limitation, a photoplethysmogram (PPG), oxygen saturation (via a pulse oximeter sensor), or heart rate. The sensing array 170 may be referred to herein as a rear-facing sensing array since the optical modules are oriented towards the rear, rather than the front, of the device 100.

In some examples, the optical modules 182 are configured to emit a first optical signal and the optical modules 183 are configured to detect a second optical signal transmitted back to the device. For example, the second optical signal may include light from the first optical signal that is reflected from the skin or dermal layers of the user and back to the device 100, also referred to as a reflection of the first optical signal. The example of FIG. 1B is not limiting and the electronic device may include a greater or a lesser number of optical modules. Further, the arrangement of emitter modules and receiver modules is not limited to that shown in FIG. 1B.

The optical module 182 may also be referred to herein as an emitter module. An emitter module may emit light over at least a portion of the visible spectrum (e.g., green light and/or red light), in which case the optical signal may be a visible (light) signal. Alternately or additionally, the emitter module may emit light over a near-IR wavelength range, in which case the optical signal may be a near-IR (light) signal. The emitter module may include a light emitting element which may be a light-emitting diode (LED) or a laser such as a vertical-cavity surface-emitting laser (VCSEL).

The optical module 183 may also be referred to herein as a receiver module. The receiver module may include a light receiving element, which may be a photodetector. The photodetector may include one or more photodiodes, phototransistor, or other optically sensitive elements.

The sensing array 170 may include one or more sensor assemblies. For example, the one or more sensor assemblies may be one or more health monitoring sensor assemblies or biosensor assemblies, such as an electrocardiogram (ECG or EKG) sensor, a photoplethysmogram (PPG) sensor, heart rate sensor, atrial fibrillation (afib) detection, electrodermal activity (EDA) sensor, a pulse oximeter or other oxygen sensor or other bio-sensor configured to take a bio-measurement (e.g., a physiological parameter). In some cases, a sensor assembly is configured to illuminate the tissue of a user wearing the device and then measure light that is transmitted back to the device.

In some embodiments, the sensing array 170 includes a biosensor assembly which includes one or more emitter modules and one or more receiver modules. For example, a heart rate biosensor may include an emitter module which produces a visible light signal (e.g., green light) and which produces an infrared light signal. As another example, a pulse oximetry biosensor (e.g., an SpO₂ sensor) may include an emitter module which produces an optical signal over a wavelength range at which the absorption of oxygenated hemoglobin and deoxygenated hemoglobin is different (e.g., red light) and which produces an optical signal over a wavelength range at which the absorption of oxygenated hemoglobin and deoxygenated hemoglobin is similar (e.g., green light or infrared light). The biosensor assembly may include a chassis positioned below the rear cover assembly 124 and the emitter module(s) and receiver module(s) may be attached to the chassis.

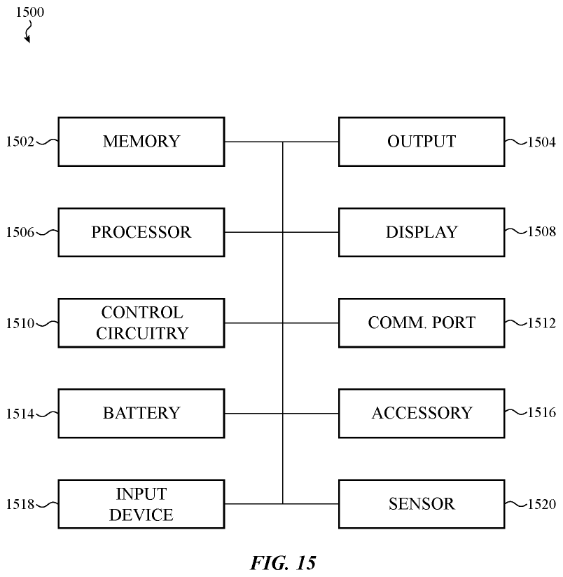

In addition to the display assembly 142 and the sensing array 170, the electronic device 100 may include additional components. These additional components may comprise one or more of a processing unit, control circuitry, memory, an input/output device, a power source (e.g., battery), a charging assembly (e.g., a wireless charging assembly), a network communication interface, an accessory, and a sensor. For example, the electronic device 100 may include one or more wireless charging coils that are at least partially enclosed by one or more of the ceramic-based components. The wireless charging coils may be part of a wireless charging assembly that is configured to receive wireless power from an external device or charger as part of an inductive charging operation. Components of a sample electronic device are discussed in more detail below with respect to FIG. 15 and the description provided with respect to FIG. 15 is generally applicable herein.

FIG. 2 shows a cross-section view of an electronic device. The electronic device 200 may be similar to the electronic device 100 of FIGS. 1A and 1B and the cross-section may be taken along A-A of FIG. 1A. The enclosure 205 of the electronic device 200 defines an interior cavity 201 and includes an enclosure component 210, a front cover assembly 222, and a rear crystal 236.

As previously described with respect to the enclosure component 110, the enclosure component 210 may be a composite enclosure component that is formed at least in part from a composite material. In embodiments, the composite material comprises a porous ceramic that is least partially embedded in a matrix material. As described in more detail with respect to FIG. 4, the matrix material may be a glass-based matrix material that includes a set of nanoparticles. In some instances, the nanoparticles are metallic nanoparticles configured to impart a color to the glass-based matrix. The description provided with respect to FIG. 4 is generally applicable herein.

The front cover assembly 222 includes a front cover member 232. A display assembly 242 is provided below the front cover assembly 222 and may be coupled to the front cover member 232. The display assembly 242 (also referred to simply as a display) includes a display layer. The display assembly 242 may also include a touch sensor layer and be referred to as a touch-sensitive display. The display layer may include a liquid-crystal display layer (LCD), a light-emitting diode (LED) display layer, an LED-backlit LCD display layer, an organic light-emitting diode (OLED) display layer, an active layer organic light-emitting diode (AMOLED) display layer, and the like. The touch sensor layer may be configured to detect or measure a location of a touch along the exterior surface of the front cover assembly 222.

In the example of FIG. 2, the front cover member 232 defines a substantially flat central portion and a curved peripheral portion surrounding the flat central portion and coinciding with a curved side surface 206 of the electronic device 200. The front cover member 232 may be substantially transparent or include one or more substantially transparent portions as previously described with respect to the front cover member 132. The front cover member 232 may be formed from any of the materials previously described for the front cover member 132 and the front cover assembly 222 may include any of the exterior and/or interior coatings previously described for the front cover assembly 122.

The device 200 includes a rear crystal 236, which may also be referred to herein as a rear cover member 236. The rear crystal 236 is coupled to the enclosure component 210 and is positioned within an opening defined by the enclosure component 210. In this example, the enclosure component defines the rear cover member that was described with respect to FIG. 1B. The rear crystal 236 defines an opening and at least partially defines a rear surface 204 of the electronic device.

The rear crystal 236 is positioned over at least a portion of a sensing array 270 of the electronic device 200. The rear crystal 236 may be at least partially transparent. For example, the rear crystal 236 may be substantially transparent to light in the visible spectrum and the infrared spectrum. In some cases, the rear crystal 236 may be formed from a ceramic material (e.g., sapphire or transparent zirconia), a glass ceramic material, or a glass material.

As previously described with respect to the sensing array 170, the sensing array 270 may include one or more sensor assemblies. For example, the one or more sensor assemblies may be one or more health monitoring sensor assemblies or biosensor assemblies, such as an electrocardiogram (ECG or EKG) sensor, a photoplethysmogram (PPG) sensor, heart rate sensor, atrial fibrillation (afib) detection, electrodermal activity (EDA) sensor, a pulse oximeter or other oxygen sensor or other bio-sensor configured to take a bio-measurement (e.g., a physiological parameter). In some cases, a sensor assembly is configured to illuminate the tissue of the user wearing the device and then measure light that is transmitted back to the device. The additional description of sensing arrays provided with respect to the sensing array 170 is generally applicable herein and, for brevity, is not repeated here.

As shown in FIG. 2, the electronic device 200 also includes a wireless charging assembly 282 that includes one or more wireless charging coils 283 that are at least partially enclosed by the enclosure component 210 and/or the rear crystal 236. The wireless charging coils 283 may be adapted to receive wireless power (via inductive coupling) from an external device or charger, which may be used to power the electronic device 200 and/or charge a battery. In some implementations, the wireless charging coils 283 are configured to inductively couple to the external device or charger through the composite enclosure component 210.

The electronic device 200 may include one or more internal antenna elements that are configured to transmit and/or receive wireless communication signals or other wireless signals from an external device or wireless device network. In some implementations the front cover assembly is configured to pass a wireless signal between the antenna elements and an external device or element in order to facilitate reliable wireless communications and other operations of the antenna. In additional implementations the composite enclosure component may be configured to pass a wireless signal between an antenna element and an external device or element in order to facilitate reliable wireless communications and other operations of the antenna. The one or more internal antenna elements may be included in the wireless communication assembly 297 shown in FIG. 2. The antenna element(s) may be part of one or more antenna assemblies. The wireless signals may be radio-frequency signals and the internal elements may be radio-frequency components.

In addition to the display assembly 242, the sensing array 270, the wireless charging assembly 282, and the wireless communication assembly 297, the electronic device may include additional components 299 located within the cavity 201. These additional components may comprise one or more of a processing unit, control circuitry, memory, an input/output device, a power source (e.g., battery), a network communication interface, an accessory, and a sensor. Components of a sample electronic device are discussed in more detail below with respect to FIG. 15 and the description provided with respect to FIG. 15 is generally applicable herein.

FIG. 3 shows another cross-section view of an electronic device. The electronic device 300 may be similar in many respects to the electronic devices 100 and 200 of FIGS. 1A, 1B, and 2 and the cross-section may be taken along A-A of FIG. 1A.

The enclosure 305 of the electronic device 300 defines an interior cavity 301. In contrast to the electronic device 200 of FIG. 2, the enclosure component 310 largely defines both the side surface 306 and the rear surface 304 of the electronic device 300.

As previously described with respect to the enclosure component 110, the enclosure component 310 may be a composite enclosure component that is formed at least in part from a composite material. In embodiments, the composite material comprises a porous ceramic that is least partially embedded in a matrix material. As described in more detail with respect to FIG. 4, the matrix material may be a glass-based matrix material that includes a set of nanoparticles. In some instances, the nanoparticles are metallic nanoparticles configured to impart a color to the glass-based matrix.

The front cover assembly 322, the front cover member 332, the front surface 302, the display assembly 342, the sensing array 370, the wireless charging assembly 382, the wireless charging coil 383, the wireless communication assembly 397, and the additional components 399 may be similar to the front cover assembly 222, the front cover member 232, the front surface 202, the display assembly 242, the rear crystal 236, the sensing array 270, the wireless charging assembly 282, the wireless charging coil 283, the wireless communication assembly 297, and the additional components 299 and those details are not repeated here.

FIG. 4 shows an enlarged view of an enclosure component of an electronic device. The enclosure component 410 may be a composite enclosure component as described herein. For example, the view of FIG. 4 may be an example of the detail area 1-1 in FIG. 1A.

As shown in the enlarged view of FIG. 4, the composite enclosure component 410 includes a ceramic structure 415 that defines a plurality of pores. The pores are filled with a matrix material 417 and the openings 416 of the pores are visible at the surface 442 of the composite enclosure. The ceramic structure 415 may also be described as being at least partially embedded in the matrix material 417. As discussed in more detail below, the matrix material 417 typically differs in composition from the ceramic structure 415 and, for example, may be a glass-based matrix material. Therefore, a surface region of the composite enclosure component 410 is formed at least in part from a composite material.

In the example of FIG. 4, the ceramic structure defines a network of conjoined ceramic structural elements 425, which may be referred to as struts. In some examples, the structural elements of the network may define a repeating pattern. For example, the ceramic structure may define a repeating pattern of closed geometric shapes such as diamonds, squares, triangles, or the like, and combinations of these, with the structural elements defining the sides of the geometric shapes. A ceramic structure that defines a repeating pattern of shapes may also be referred to as a ceramic lattice structure herein. The network of conjoined ceramic structural elements 425 may also define a pore network. In several examples described herein, the matrix material 417 also includes nanoparticles, such as metallic nanoparticles.

Inclusion of this composite material in the enclosure component can provide multiple advantages. For example, an enclosure including a ceramic structure at least partially embedded in a glass-based matrix may have an enhanced toughness as compared to an enclosure formed solely of the glass material. In some examples, toughness may be measured by an indentation fracture toughness test, such as a fracture toughness test using a Vickers or a Berkovich indenter. Alternately, the toughness may be measured with a chevron-notch or straight sharp notch three-point bending test.

Some ceramic materials with useful mechanical properties may have a dielectric constant that is higher than is preferred for use over a component of a wireless communication system. Therefore, combining the ceramic material with a glass material having a lower dielectric constant can produce an enclosure component having a dielectric constant that is acceptable for use with internal components of a wireless communication system. Furthermore, the metallic nanoparticles of the composite material can help to provide a chromatic color to the enclosure component.

In some embodiments, the ceramic structure defines a three-dimensional network, which may also be referred to as a reticulated structure. In some cases, the three-dimensional network extends across a substantial entirety of the enclosure component. In some examples, the three-dimensional network may be substantially uniform across the entire enclosure component while in other examples, the three-dimensional network may be non-uniform. As a particular example, the three-dimensional network may be formed so that it defines an opening in order to facilitate formation of a hole through the enclosure or to define a lower dielectric constant window for an internal device component. In other cases, the three-dimensional network may extend across less than a substantial entirety of the enclosure component. For example, the three-dimensional network may be localized to specific regions of the enclosure component, such as a corner region of the enclosure component. In some embodiments, the composite material includes from 10 vol % to 70 vol %, from 20 vol % to 60 vol %, or from 20 vol % to 50 vol % of the ceramic material that defines the ceramic structure.

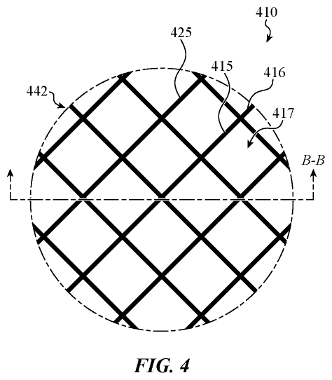

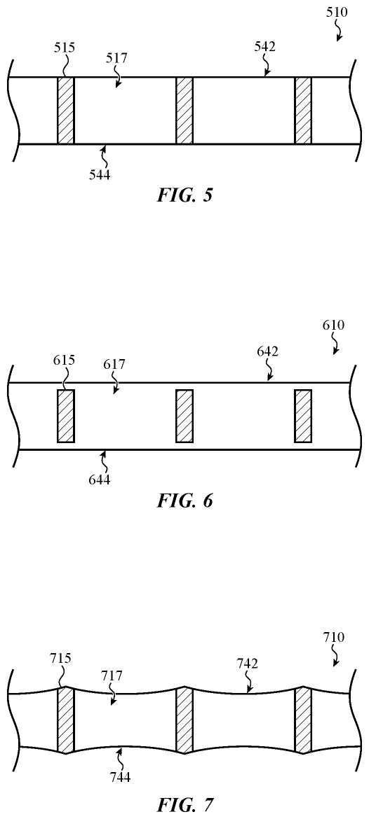

In some cases, the three-dimensional network spans a thickness of the enclosure component, as shown in the example cross-sectional views of FIGS. 5 and 7. However, in other cases, the three-dimensional network does not span the thickness of the enclosure component and the top and/or the bottom surfaces may be defined by the matrix material 417, as shown in the example cross-sectional view of FIG. 6. The three-dimensional networks shown in FIGS. 5-12 are simplified for convenience of illustration and the disclosure is not limited to these examples. For example, the disclosure herein also relates more generally to three-dimensional networks that define networks of interconnected pores to facilitate flow of molten glass material into the pore network.

In the example of FIG. 4, the ceramic structure 415 defines a series of diamond shaped pore openings 416. However, this example is not intended to be limiting and the ceramic structure may define pore openings that are rectangular, circular, oval, or irregular in shape. Furthermore, although the pore openings 416 shown in FIG. 4 are substantially uniform in size, in additional examples the pore openings may vary in size. In some embodiments, a median size (e.g., a median diameter) of the pores ranges from 100 micrometers to 5 millimeters, from 100 micrometers to 2 millimeters, from 500 micrometers to 5 millimeters, or from 500 micrometers to 2 millimeters.

In some examples, the porous ceramic structure may be formed of a zirconia-based material or an alumina-based material. For example, the zirconia-based material may be a partially stabilized zirconia that predominantly includes zirconia (zirconium oxide) crystals stabilized with an oxide such as yttrium oxide. As another example, the zirconia-based material may be an alumina toughened zirconia ceramic material that predominantly includes zirconia but that also includes fine particles of alumina (aluminum oxide). The ceramic materials may also include other components such as coloring agents and/or processing agents. In some examples, the structural elements of the porous ceramic structure may be opaque or translucent. In some instances, the ceramic material may have a dielectric constant from 3 to 15, from 3 to 10, from 5 to 20, or from 10 to 30. The porous ceramic structure may be formed by a variety of techniques, including, but not limited to, three-dimensional printing, foaming, or sponge replication. In some examples, the porous ceramic structure may have a thickness that ranges from 500 nm to 5 mm or from 1 mm to 10 mm.

As previously discussed with respect to FIGS. 1A and 1B, the matrix material 417 may be glass-based, and may therefore be referred to as a glass-based matrix or alternately as a glass-based matrix material. The glass-based matrix material may predominantly include a glass material but may include one or more sets of nanoparticles. The glass material typically has a lower melting point than the ceramic material of the ceramic structure 415. The ceramic structure 415 may be at least partially embedded in the matrix material 417.

The glass-based matrix material may have a coefficient of thermal expansion that is substantially matched to a coefficient of thermal expansion of the ceramic material of the ceramic structure. In some instances, the glass material is a silicate-based glass, such as an aluminosilicate glass or a boroaluminosilicate glass. As used herein, an aluminosilicate glass includes the elements aluminum, silicon, and oxygen, but may further include other elements. Similarly, a boroaluminosilicate glass includes the elements boron, aluminum, silicon, and oxygen, but may further include other elements. For example, an aluminosilicate glass or a boroaluminosilicate glass may further include monovalent or divalent ions which compensate charges due to replacement of silicon ions by aluminum ions. Suitable monovalent ions include, but are not limited to, alkali metal ions such as Li⁺, Na⁺, or K⁺, such as in alkali aluminosilicate glass. Suitable divalent ions include alkaline earth ions such as Ca²⁺ or Mg²⁺, such as in an alkaline earth aluminosilicate glass. In embodiments, the glass material is ion exchangeable. In additional examples, the aluminosilicate glass or a boroaluminosilicate glass may further include dopants for the reinforcing phase(s) to be formed in the composite component (such as metal ions). In some examples, the aluminosilicate glass or a boroaluminosilicate glass may further include elements which stabilize the dopants during the melting process to allow formation of the reinforcing phase during a later heat treatment phase. In some embodiments, the silicate glass may be substantially free of tungsten or molybdenum (e.g., formed from a composition that is substantially free of tungsten oxide and/or molybdenum oxide). In some embodiments, the silicate glass may be substantially free of a conventional ultraviolet (UV) light activated photosensitizing agent for nucleation of metallic nanoparticles.

In some cases, the glass-based matrix material is chemically strengthened by ion exchange. For example, an ion-exchangeable glass or glass ceramic material may include monovalent or divalent ions such as alkali metal ions (e.g., Li⁺, Na⁺, or K⁺) or alkaline earth ions (e.g., Ca²⁺ or Mg²⁺) that may be exchanged for other alkali metal or alkaline earth ions. If the glass or glass ceramic material comprises sodium ions, the sodium ions may be exchanged for potassium ions. Similarly, if the glass or glass ceramic material comprises lithium ions, the lithium ions may be exchanged for sodium ions and/or potassium ions. Exchange of smaller ions in the glass or glass ceramic material for larger ions can form a compressive stress layer along a surface of the glass or glass ceramic material. Formation of such a compressive stress layer can increase the hardness and impact resistance of the glass or glass ceramic material.

As previously discussed with respect to FIGS. 1A and 1B, in some embodiments the matrix material 417 also includes a set of metallic nanoparticles embedded in the glass material. The metallic nanoparticles may be formed from one or more metals. In some cases, the metallic nanoparticles are formed of one or more transition metals such as titanium, chromium, vanadium, manganese, iron, cobalt, nickel, copper, silver, gold, and the like. The nanoparticles may have a size less than 1 micrometer, such as from 10 nm to less than 1 micrometer, from 15 nm to 200 nm, from 15 nm to 150 nm, from 15 nm to 100 nm, from 20 nm to 100 nm, from 50 nm to 150 nm, from 50 nm to 150 nm, or from 100 nm to 200 nm. For example, an average size of the metallic particles may fall within one of these size ranges. In some examples, metallic nanoparticles may have a generally rounded shape, such as a spherical shape, or an elongated shape, such as a prolate spheroid. In some examples, the metal of the metallic nanoparticles may be present in a concentration greater than or equal to 0.01 mol % and less than or equal to 0.5 mol %, 1 mol %, 2 mol %, 4 mol %, 6 mol %, 8 mol %, or 10 mol %. As specific examples, the metal of the metallic nanoparticles may be present at a concentration from 0.01 mol % to 2 mol %, from 0.5 mol % to 2 mol %, from greater than 5% to 10 mol % or from greater than 7 mol % to 10 mol %.

In embodiments, the metallic nanoparticles may help to impart a color to the composite enclosure component. For example, the metallic nanoparticles may absorb certain wavelengths of visible light via plasmon resonance absorption. Therefore, the composite cover member may have a characteristic hue (alternately, a chromatic color) due at least in part to this absorption of light. In further embodiments, the metallic nanoparticles may help increase the toughness of the composite enclosure component as compared to a similar enclosure component which is substantially free of the metallic nanoparticles. For example, when a concentration of the metallic nanoparticles is sufficiently high and/or the interparticle spacing of the metallic nanoparticles is sufficiently low, the presence of the metallic nanoparticles may help to arrest propagation of a crack through the composite component. As an additional example, when the metallic nanoparticles are more ductile than the glass-based matrix, the ductility of the metallic nanoparticles also help arrest propagation of a crack through the composite component. In some cases, the increased toughness may be indicated by a reduced hardness of the composite enclosure component as compared to a similar enclosure component that is free of the metallic nanoparticles.

In some embodiments, the nanoparticles are non-metallic particles, such as semiconductor particles or ceramic particles. The non-metallic particles may have a size less than 1 micrometer, such as from 10 nm to less than 1 micrometer, from 10 nm to less than 100 nm, from 15 nm to 200 nm, from 15 nm to 150 nm, from 15 nm to 100 nm, from 20 nm to 100 nm, from 50 nm to 150 nm, from 50 nm to 200 nm, or from 100 nm to 200 nm. For example, an average size of the non-metallic particles may fall within one of these size ranges.

Semiconductor nanoparticles may be nanoparticles of a compound semiconductor. In some examples, the compound semiconductor may be a metal oxide semiconductor, such as a zinc oxide (e.g., ZnO or ZnO₂), a titanium oxide (e.g., TiO₂), or a tin oxide (e.g., SnO₂). In some cases, zinc oxide, titanium oxide, and tin oxide semiconductors can primarily absorb UV light, rather than visible light. Therefore, nanoparticles formed from these materials can have limited absorption over the visible wavelength range and may not substantially change the color of the composite component. In some embodiments, the semiconductor nanoparticles are substantially free of tungsten or molybdenum. Compound semiconductors may alternately be classified by the periodic table groups of their elements, such as an II-VI semiconductor, a III-V semiconductor, an IV-VI semiconductor, or an IV compound semiconductor. For example, II-VI semiconductors include, but are not limited to ZnO, ZnS, ZnSe, ZnTe, CdS, and CdSe. In some cases, the semiconductor may be a ternary semiconductor rather than a binary semiconductor.

In some embodiments, the semiconductor nanoparticles may help impart a color to the composite enclosure component. For example, the semiconductor nanoparticles may absorb certain wavelengths of visible light (e.g., when the semiconductor has a band gap that lies in the visible region). Therefore, the composite cover member may have a characteristic hue (alternately, a chromatic color) due at least in part to this absorption of light. In other embodiments, the semiconductor nanoparticles do not significantly absorb light in the visible spectrum and therefore the presence of the semiconductor nanoparticles in the glass does not significantly change the color of the glass. In some examples, the semiconductor nanoparticles have a size and a refractive index that does not produce undue scattering of visible light within the composite component. However, the semiconductor nanoparticles may modify a mechanical property of the glass. For example, when a concentration of the semiconductor nanoparticles is sufficiently high and/or an interparticle spacing of the semiconductor nanoparticles is sufficiently low, the presence of the semiconductor nanoparticles may help to arrest propagation of a crack through the composite component.

The color of the composite enclosure component may be characterized in several ways. For example, the color of the composite enclosure component may be characterized by coordinates in CIEL*a*b* (CIELAB) color space. In CIEL*a*b* (CIELAB) color space, L* represents brightness, a* the position between red/magenta and green, and b* the position between yellow and blue. Alternately or additionally, the color of the composite enclosure component may be characterized by coordinates in L*C*h* color space, where C* represents the chroma and h_{ab} represents the hue angle (in degrees). The chroma C* is related to a* and b* as C*=\sqrt{(a*)²+(b*)²}. In addition, the hue angle h_{ab} is related to a* and b* as

$${h}_{a b} = {tan}^{- 1} \frac{b *}{a *} .$$

A broadband or semi-broadband illuminant may be used to determine the color of a portion of the cover member or cover assembly. For example, a CIE illuminant or other reference illuminant may be used. In some cases, the color of the cover member may be determined from light transmitted through the cover member. In additional cases, the color of the composite enclosure component may be determined from light reflected back through the cover member (e.g., using a white background). The CIELAB or L*C*h coordinates for a given illuminant can be measured with a device such as a colorimeter or a spectrophotometer or calculated from transmission or reflectance spectra.

In some examples, a color of a composite enclosure component is characterized by an a* value having a magnitude greater than or equal to 0.25, greater than or equal to 0.5, greater than or equal to 0.75, or greater than or equal to 1. In additional examples, the color of the composite enclosure component is characterized by a b* value having a magnitude greater than or equal to 1, greater than or equal to 1.5, or greater than or equal to 2. In further examples, the color of the composite enclosure component may have an L* value of at least 20, at least 80, at least 85, or at least 90. The color of the composite enclosure component may be characterized by having a C* value greater than 1.75, greater than 2, or greater than 2.5. When a color difference between two different portions of the composite enclosure component is desired, the chroma difference (ΔC*) between the two different portions may be at least 1, at least 2, at least 5, at least 10, at least 15, at least 20, at least 25, or ranging from 1 to 10, 5 to 20, or 15 to 50. These color values may relate to the matrix portion of the composite enclosure component.

In some cases, the color of the enclosure may also be due in part to the presence of a coating along an internal surface of the composite enclosure component. The perceived color of the enclosure may be due at least in part to light reflected or otherwise directed back out of the composite enclosure component by the metallic and/or non-metallic nanoparticles and by reflection at interface between the composite cover component and the internal coating. In some cases, the spectrum of light reflected from the internal coating is similar to that incident on the coating (e.g., for a neutral coating having a* and b* near zero). In additional cases, the coating selectively absorbs some of the incident light, so that the color of the enclosure may differ from that of the composite enclosure component (without the coating). The coating may include a polymer-based color that layer that includes a pigment or dye.

In embodiments, the composite enclosure component 410 may be made by a process including an operation in which a molten or softened glass material is introduced into least some of the pores defined by the ceramic structure to produce a workpiece of the composite material. For example, the molten or softened glass material may substantially fill surface pores of the ceramic structure. The molten or softened glass material may or may not penetrate through a thickness of the ceramic structure. Even if the molten or softened glass material penetrates through the thickness of ceramic structure, not all the pores defined by the ceramic structure need be filled by the molten glass material. The molten or softened glass material may be introduced into the pores of the ceramic structure in a controlled atmosphere furnace, such as furnace that can produce a vacuum and/or an inert gas atmosphere, such as an argon atmosphere. The molten or softened glass may be at a temperature greater than or equal to a working temperature or a melting point of the glass. After the molten or softened glass is introduced into pores of the ceramic structure, the glass is then cooled (e.g., below its glass transition temperature), forming a composite workpiece.

The composite workpiece may be treated to produce the desired surface profile of the composite enclosure component. For example, the composite workpiece may be machined, ground, and/or polished. In some examples, the surface profile has portions defined by the matrix material which are flush with or recessed with respect to portions defined by the ceramic structure, examples of which are shown in FIGS. 5 and 7. As an additional example, the surface profile may be defined by the matrix material and the ceramic structure may be covered by the matrix material as shown in FIG. 6. The surface of the composite workpiece may also be treated to produce a desired surface texture, such as a texture producing a glossy effect, a matte effect, or a combination of these.

The nanoparticles may be formed in the composite workpiece before the composite workpiece is treated to produce the desired surface profile or may be formed in the composite enclosure component after the desired surface profile is formed. In some cases, the nanoparticles are formed within all the matrix portions of in the composite workpiece using a furnace or the like. In other cases, the nanoparticles are locally formed in the matrix portions of the composite workpiece or enclosure component using a localized heat source such as a laser. In some instances when the nanoparticles are locally formed in the matrix portions, the ceramic structure may thermally insulate neighboring matrix portions, thereby facilitating formation of different sets of nanoparticles in neighboring matrix portions.

The nanoparticles embedded in the matrix material of the composite enclosure component may be uniformly or non-uniformly distributed. In some cases, the nanoparticles are uniformly distributed in matrix portions of the composite enclosure component. Even when the nanoparticles are uniformly distributed in the matrix portions of the composite enclosure component, a difference in the color of the ceramic structure and the color produced by the metallic nanoparticles may produce a stained-glass effect in which the matrix portions are outlined by the ceramic structure at the surface of the composite enclosure component. The metallic nanoparticles may also be uniformly distributed through the thickness of the enclosure component or may vary in concentration through the thickness. In some examples, the metallic nanoparticles may be confined to a surface region of the enclosure component.

In additional cases, the metallic nanoparticles are not uniformly distributed between the matrix portions of the composite enclosure component. These matrix portions may define respective portions of a surface of the composite enclosure component, so that the difference in the distribution of the nanoparticles may produce optical effects visible at that surface (e.g., an exterior surface of the composite enclosure component). As one example, the composite nanoparticles may be formed only in some of the matrix portions of the composite enclosure component, so that at least one other matrix portion of the composite enclosure component is substantially free of the metallic nanoparticles. As previously discussed, the nanoparticles may absorb certain wavelengths in the visible spectrum and may produce or contribute to a chromatic color of the matrix portions in which they are present. The at least one other matrix portion may have a neutral color or may have a chromatic color that has a lower chroma than that of the matrix portions including the metallic nanoparticles. For example, a matrix portion having a neutral color may have an a* value having a magnitude (alternately, absolute value) less than 0.5, and a b* value having a magnitude less than 1.

As another example, a first set of metallic nanoparticles may be formed in a first matrix portion of the composite enclosure component and a second set of metallic nanoparticles may be formed in a second matrix portion of the composite enclosure component. The first set of metallic nanoparticles may be distributed in the first matrix portion and have a first light absorption in the visible spectrum, with the metallic nanoparticles of the first set absorbing certain wavelengths in the visible spectrum. The first set of metallic nanoparticles may be configured so that the first absorption produces a first chromatic color of the first matrix region. The second set of metallic nanoparticles may be distributed in a second matrix portion and having a second light absorption, different from the first light absorption, in the visible spectrum, with the metallic nanoparticles of the second set absorbing different wavelengths in the visible spectrum than the metallic nanoparticles of the first set. The second set of metallic nanoparticles may be configured so that the second absorption produces a second chromatic color different from the first chromatic color. As examples, the first set of metallic nanoparticles may have a shape, size, and/or concentration that is different from that of the second set of metallic nanoparticles. In some examples, the first matrix portion may be positioned in a first pore of the pore network and the second matrix portion may be positioned in a second pore that is adjacent to the first pore. In other words, the first pore and the second pore may be neighboring pores that are separated by an intervening portion of the ceramic structure. The first matrix portion may define a first portion of an exterior surface of the enclosure component and the second matrix portion may define a second portion of the exterior surface of the enclosure component.

As a further example, the size and/or concentration of the metallic nanoparticles may vary along adjacent (alternately, neighboring) matrix portions of the composite enclosure component. In some cases, this variation in size and/or concentration may produce a gradual decrease or increase in concentration along neighboring matrix portions of the composite enclosure component. In other cases, the variation may produce a step change in the concentration. This variation in the size and/or concentration of the metallic nanoparticles along the external surface of the composite enclosure component may produce a chromatic color variation along the exterior surface of the composite enclosure. In some cases, this variation in concentration may be localized to an external surface region of the composite.

FIG. 5 shows a cross-section view of an enclosure component. In the example of FIG. 5, the enclosure component 510 is a composite enclosure component that includes a ceramic structure 515 and a matrix material 517. As previously discussed with respect to FIG. 4, the matrix material 517 may include a glass material and nanoparticles embedded in the glass material. The view of FIG. 5 may be an example of a cross-section along B-B in FIG. 4.

As shown in FIG. 5, the ceramic structure 515 spans a thickness of the composite enclosure component 510. In other words, the ceramic structure 515 defines a portion of both the top surface 542 and the bottom surface 544 of the composite enclosure component 510. The matrix material 517 defines another portion of both the top surface 542 and the bottom surface 544. In the example of FIG. 5, the portions of the top surface 542 defined by the ceramic structure 515 and the matrix material 417 are substantially flush with one another. The portions of the bottom surface 544 defined by the ceramic structure 515 and the matrix material 517 are also substantially flush with one another. Such a structure may be obtained by machining the top and bottom surfaces of a workpiece of the composite material as previously described with respect to FIG. 4.

The ceramic structure 515 shown in FIG. 5 is simplified for convenience of illustration and the disclosure is not limited to this example. In additional examples, the ceramic structure 515 defines additional ceramic structural elements configured to provide an interconnected pore network. In such pore networks, the interconnected pores defined by the ceramic structure may extend through a thickness of the composite enclosure element, but these interconnected pores need not be coplanar.

FIG. 6 shows a cross-section view of another enclosure component. In the example of FIG. 6, the enclosure component 610 is a composite enclosure component that includes a ceramic structure 615 and a matrix material 617. As previously discussed with respect to FIG. 4, the matrix material 617 may include a glass material and nanoparticles embedded in the glass material. The view of FIG. 6 may be an example of a cross-section along B-B in FIG. 4.

In the example of FIG. 6, the top and bottom surface profiles are defined by the matrix material 617 and the ceramic structure 615 is covered by the matrix material. Such a surface profile may be formed by limiting removal of glass from the composite workpiece so that the ceramic structure 615 is not exposed. Therefore, the matrix material 617 defines both the top surface 642 and the bottom surface 644 of the composite enclosure component 610.

The ceramic structure 615 shown in FIG. 6 is simplified for convenience of illustration and the disclosure is not limited to this example. In additional examples, the ceramic structure 615 defines additional ceramic structural elements configured to provide an interconnected pore network in a similar fashion as previously described with respect to FIG. 5.

FIG. 7 shows a cross-section view of another enclosure component. In the example of FIG. 7, the enclosure component 710 is a composite enclosure component that includes a ceramic structure 715 and a matrix material 717. As previously discussed with respect to FIG. 4, the matrix material 717 may include a glass material and nanoparticles embedded in the glass material. The view of FIG. 7 may be an example of a cross-section along B-B in FIG. 4.

As shown in FIG. 7, the ceramic structure 715 spans a thickness of the composite enclosure component 710. In other words, the ceramic structure 715 defines a portion of both the top surface 742 and the bottom surface 744 of the composite enclosure component 710. The matrix material 717 defines another portion of both the top surface 742 and the bottom surface 744. In contrast to the example of FIG. 5, the portions of the top surface 742 defined by the ceramic structure 715 and the matrix material 717 are not substantially flush with one another, but some regions of the matrix material 717 are recessed with respect to the ceramic structure 715. The portions of the bottom surface 744 defined by the ceramic structure 715 and the matrix material 717 are also not substantially flush with one another.

The ceramic structure 715 shown in FIG. 7 is simplified for convenience of illustration and the disclosure is not limited to this example. In additional examples, the ceramic structure 715 defines additional ceramic structural elements configured to provide an interconnected pore network in a similar fashion as previously described with respect to FIG. 5.

FIG. 8 shows a magnified cross-section view of an enclosure component. In the example of FIG. 8, the enclosure component 810 is a composite enclosure component that includes a ceramic structure 815 and a matrix material 817. The matrix material 817 includes a glass material 862 and nanoparticles 852 embedded in the glass material. The view of FIG. 8 may be an enlarged view of the cross-section of FIG. 5.

The nanoparticles 852 are shown as having a generally uniform concentration through a thickness of the composite enclosure component 810. However, this example is not limiting and in other examples the nanoparticles may have a higher concentration at one surface than another, as schematically shown in the example of FIG. 11. In further examples, the nanoparticles may be present in a region extending from one surface (e.g., a surface region) but another region extending from another surface may be substantially free of the nanoparticles.

The nanoparticles 852 are shown as having a circular cross-section in the example of FIG. 8, consistent with nanoparticles having a spherical shape. However, this example is not limiting and in other examples, the nanoparticles may have an elongated shape and/or may have a cross-section that is not spherical. The nanoparticles may be metallic nanoparticles. The nanoparticles described herein are typically solid particles and the depiction of nanoparticles with open circles herein is not intended to indicate that the nanoparticles are largely hollow. The description of metallic nanoparticles previously provided with respect to FIG. 4 is generally applicable herein and is not repeated here. The ceramic structure 815 shown in FIG. 8 is simplified for convenience of illustration and the disclosure is not limited to this example. In additional examples, the ceramic structure 815 defines additional ceramic structural elements configured to provide an interconnected pore network in a similar fashion as previously described with respect to FIG. 5.

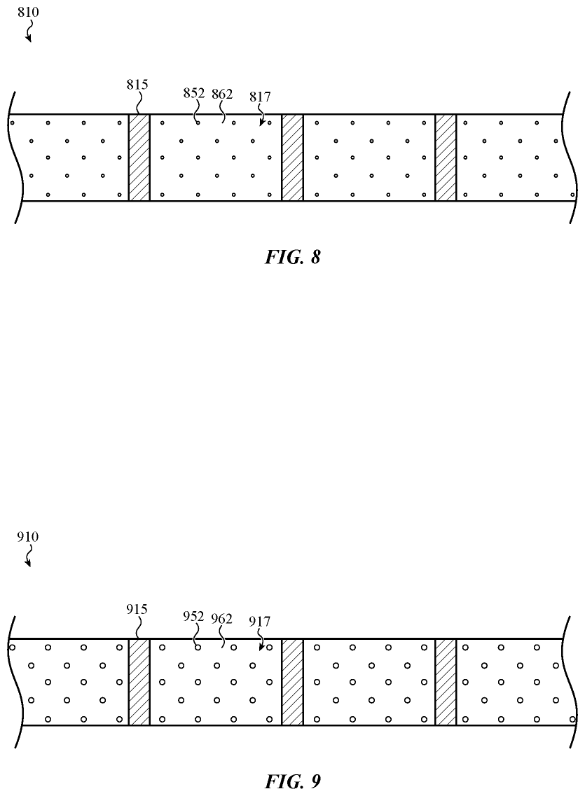

FIG. 9 shows a magnified cross-section view of another enclosure component. In the example of FIG. 9, the enclosure component 910 is a composite enclosure component that includes a ceramic structure 915 and a matrix material 917. The matrix material 917 includes a glass material 962 and nanoparticles 952 embedded in the glass material. The view of FIG. 9 may be another enlarged view of the cross-section of FIG. 5.

The nanoparticles 952 of FIG. 9 are larger than the nanoparticles 852 of FIG. 8. In some cases, the nanoparticles 952 may represent nanoparticles present in one matrix portion of a composite enclosure component and the nanoparticles 852 may represent particles present in another matrix portion of the composite enclosure component. Metallic nanoparticles having different sizes may absorb different wavelengths of light traveling through the composite enclosure component and therefore the presence of differently sized nanoparticles in the composite enclosure component may impart different colors to different portions of the enclosure component.

The nanoparticles 952 are shown as having a generally uniform concentration through a thickness of the composite enclosure component 910. However, this example is not limiting and in other examples the nanoparticles may have a higher concentration at one surface than another, as schematically shown in the example of FIG. 11. In further examples, the nanoparticles may be present in a region extending from one surface (e.g., a surface region) but another region extending from another surface may be substantially free of the nanoparticles.

The nanoparticles 952 are shown as having a circular cross-section in the example of FIG. 9, consistent with nanoparticles having a spherical shape. However, this example is not limiting and in other examples, the nanoparticles may have an elongated shape and/or may have a cross-section that is not spherical. The nanoparticles may be metallic nanoparticles. The description of metallic nanoparticles previously provided with respect to FIG. 4 is generally applicable herein and is not repeated here. The ceramic structure 915 shown in FIG. 9 is simplified for convenience of illustration and the disclosure is not limited to this example. In additional examples, the ceramic structure 915 defines additional ceramic structural elements configured to provide an interconnected pore network in a similar fashion as previously described with respect to FIG. 5.

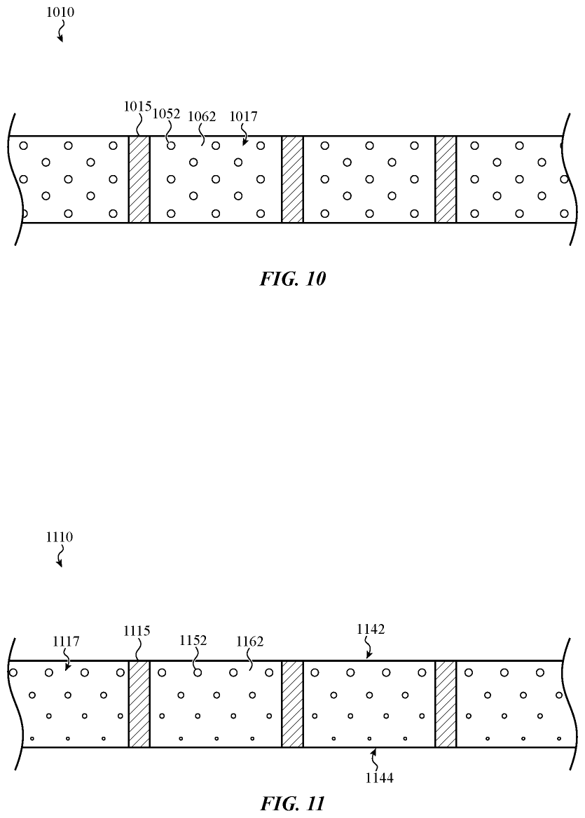

FIG. 10 shows a magnified cross-section view of another enclosure component. In the example of FIG. 10, the enclosure component 1010 is a composite enclosure component that includes a ceramic structure 1015 and a matrix material 1017. The matrix material 1017 includes a glass material 1062 and nanoparticles 1052 embedded in the glass material. The view of FIG. 10 may be another enlarged view of the cross-section of FIG. 5.

The nanoparticles 1052 of FIG. 10 are different than the nanoparticles 852 of FIG. 8 and 952 of FIG. 9. In the example of FIG. 10, the nanoparticles 1052 are larger than the nanoparticles 852 of FIG. 8 and 952 of FIG. 9. In some cases, the nanoparticles 1052 may represent nanoparticles present in one matrix portion of a composite enclosure component and the nanoparticles 852 and/or 952 may represent particles present in at least one other matrix portion of the composite enclosure component. As previously discussed, the presence of differently sized nanoparticles in the composite enclosure component may impart different colors to different portions of the enclosure component.

Alternately or additionally, the nanoparticles 1052 may be different in composition than the nanoparticles 852 or the nanoparticles 952. As one example, nanoparticles 852 and/or the nanoparticles 952 may be metallic nanoparticles having a first composition and the nanoparticles 1052 may be metallic nanoparticles having a second composition different from the first composition. As another example, the nanoparticles 1052 may be non-metallic nanoparticles and the nanoparticles 852 and/or the nanoparticles 952 may be metallic nanoparticles. In some cases, the nanoparticles 1052 may represent nanoparticles present in one matrix portion of a composite enclosure component and the nanoparticles 852 and/or 952 may represent particles present in at least one other matrix portion of the composite enclosure component. Nanoparticles having different compositions may absorb different wavelengths of light traveling through the composite enclosure component and therefore the presence of nanoparticles having different compositions in the composite enclosure component may impart different colors to different portions of the enclosure component.

The nanoparticles 1052 are shown as having a generally uniform concentration through a thickness of the composite enclosure component 1010. However, this example is not limiting and in other examples the nanoparticles may have a higher concentration at one surface than another, as schematically shown in the example of FIG. 11. In further examples, the nanoparticles may be present in a region extending from one surface (e.g., a surface region) but another region extending from another surface may be substantially free of the nanoparticles.

The nanoparticles 1052 are shown as having a circular cross-section in the example of FIG. 10, consistent with nanoparticles having a spherical shape. However, this example is not limiting and in other examples, the nanoparticles may have an elongated shape and/or may have a cross-section that is not spherical. The nanoparticles 1052 may be metallic nanoparticles or non-metallic nanoparticles. The description of metallic nanoparticles and non-metallic nanoparticles previously provided with respect to FIG. 4 is generally applicable herein and is not repeated here. The ceramic structure 1015 shown in FIG. 10 is simplified for convenience of illustration and the disclosure is not limited to this example. In additional examples, the ceramic structure 1015 defines additional ceramic structural elements configured to provide an interconnected pore network in a similar fashion as previously described with respect to FIG. 5.

FIG. 11 shows a magnified cross-section view of another enclosure component. In the example of FIG. 11, the enclosure component 1110 is a composite enclosure component that includes a ceramic structure 1115 and a matrix material 1117. The matrix material 1117 includes a glass material 1162 and nanoparticles 1152 embedded in the glass material. The view of FIG. 11 may be an enlarged view of the cross-section of FIG. 5.

The nanoparticles 1152 of FIG. 11 have a size that varies along a thickness direction of the composite enclosure component 1110. As a particular example, the particles near the surface 1142 are larger than those near the surface 1144. This size difference may be a result of greater heating of the surface 1142 as compared to the surface 1144. In some cases, the variation in the gradient in the size of the nanoparticles. The variation in the size of the nanoparticles shown in FIG. 11 is exemplary rather than limiting. For example, in cases where a laser is used to produce localized heating of the surface 1142, the size variation of the nanoparticles may reflect the heat distribution produced by the laser beam. As another example, the nanoparticles may be present in a region extending from the surface 1142 (e.g., a surface region) but another region extending from the surface 1144 may be substantially free of the nanoparticles.

Alternately or additionally, the nanoparticles 1152 of FIG. 11 may have a concentration that varies along a thickness direction of the composite enclosure component 1110. In some cases, the variation in the concentration of the nanoparticles may produce a concentration gradient in the thickness direction. When a laser is used to produce localized heating of the surface 1142, the concentration variation of the nanoparticles may reflect the heat distribution produced by the laser beam. As previously discussed, the nanoparticles may be present in a region extending from the surface 1142 (e.g., a surface region) but another region extending from the surface 1144 may be substantially free of the nanoparticles.

The nanoparticles 1152 are shown as having a circular cross-section in the example of FIG. 11, consistent with nanoparticles having a spherical shape. However, this example is not limiting and in other examples, the nanoparticles may have an elongated shape and/or may have a cross-section that is not spherical. The nanoparticles may be metallic nanoparticles. The description of metallic nanoparticles previously provided with respect to FIG. 4 is generally applicable herein and is not repeated here. The ceramic structure 1115 shown in FIG. 11 is simplified for convenience of illustration and the disclosure is not limited to this example. In additional examples, the ceramic structure 1115 defines additional ceramic structural elements configured to provide an interconnected pore network in a similar fashion as previously described with respect to FIG. 5.

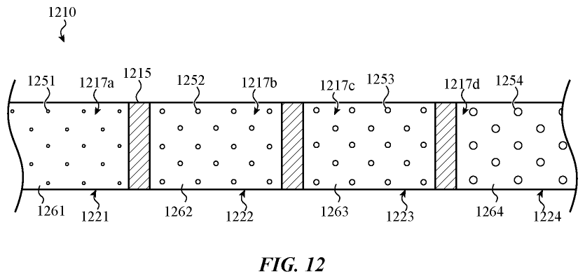

FIG. 12 shows a magnified cross-section view of another enclosure component. In the example of FIG. 12, the enclosure component 1210 is a composite enclosure component that includes a ceramic structure 1215. The enclosure component 1210 includes matrix portions 1221, 1222, 1223, and 1224. The view of FIG. 12 may be an enlarged view of the cross-section of FIG. 5.

In the example of FIG. 12, the matrix materials 1217a, 1217b, 1217c, and 1217d are different in each of the matrix portions 1221, 1222, 1223, and 1224 of the composite enclosure component 1210. As shown in FIG. 12, the nanoparticles 1252 of the matrix portion 1222 are larger than the nanoparticles 1251 of the matrix portion 1221, the nanoparticles 1253 of the matrix portion 1223 are larger than the nanoparticles 1252 of the matrix portion 1222, and the nanoparticles 1254 of the portion 1224 are larger than the nanoparticles 1253 of the matrix portion 1223. Therefore, the size of the nanoparticles varies along neighboring portions of the composite enclosure component that are defined by the matrix material.

This variation in size may produce a chromatic color variation along the exterior surface of the composite enclosure. For example, the set of metallic nanoparticles 1251 in the matrix portion 1217a may have a first light absorption in the visible spectrum. This first absorption may produce or contribute to a first chromatic color of the matrix portion 1217a. The set of metallic nanoparticles 1252 in the matrix portion 1217b may have a second light absorption, different from the first light absorption, in the visible spectrum. This second absorption may produce or contribute to a second chromatic color, different from the first chromatic color, of the matrix region 1217b. In the example of FIG. 12, the matrix portion 1217a is positioned in a first pore and the matrix portion 1217b positioned in a second pore that is adjacent to the first pore. The matrix portion 1217a may define a first portion of an exterior surface of the enclosure component and the matrix portion 1217b may define a second portion of the exterior surface of the enclosure component 1210.

Alternately or additionally, the concentration of the nanoparticles may vary along neighboring portions of the composite enclosure component that are defined by the matrix material, as previously discussed with respect to FIG. 4. This variation in the concentration of the metallic nanoparticles may produce a chromatic color variation along the exterior surface of the composite enclosure. The matrix materials 1217a, 1217b, 1217c, and 1217d respectively include glass materials 1261, 1262, 1263, and 1264 which may be different due to the differences in the nanoparticles 1251, 1252, 1253, and 1254.

The nanoparticles 1251, 1252, 1253, and 1254 are shown as having a generally uniform concentration through a thickness of each of the respective matrix portions 1221, 1222, 1223, and 1224 of the composite enclosure component 1210. However, this example is not limiting and in other examples the nanoparticles may have a higher concentration at one surface than another, as schematically shown in the example of FIG. 11. In further examples, the nanoparticles may be present in a region extending from one surface (e.g., a surface region) but another region extending from another surface may be substantially free of the nanoparticles.

The nanoparticles 1251, 1252, 1253, and 1254 are shown as having a circular cross-section in the example of FIG. 12, consistent with nanoparticles having a spherical shape. However, this example is not limiting and in other examples, the nanoparticles may have an elongated shape and/or may have a cross-section that is not spherical. Furthermore, the nanoparticles may have different shapes as well as different sizes in the different portions of the composite enclosure member 1210. The nanoparticles 1251, 1252, 1253, and 1254 may be metallic nanoparticles, which may all have the same composition or may have different compositions. The description of metallic nanoparticles previously provided with respect to FIG. 4 is generally applicable herein and is not repeated here. The ceramic structure 1215 shown in FIG. 12 is simplified for convenience of illustration and the disclosure is not limited to this example. In additional examples, the ceramic structure 1215 defines additional ceramic structural elements configured to provide an interconnected pore network in a similar fashion as previously described with respect to FIG. 5.

FIG. 13 shows a view of another enclosure component. The enclosure component is a composite enclosure component 1310 as described herein. For example, the composite enclosure component 1310 may be a unitary composite housing component for a mobile phone.

In the example of FIG. 13, the composite enclosure component 1310 largely defines a rear surface 1304 and a side surface 1306 of the electronic device. The composite enclosure component 1310 also defines through-holes 1362, 1364, and 1366. The through-holes 1362, 1364 may allow access for input members such as buttons or the like. The through-hole 1366 may allow wired charging of the electronic device or may allow input to a microphone, output from a speaker or the like.

In embodiments, the composite enclosure component 1310 includes a ceramic structure at least partially embedded in a matrix material as previously discussed with respect to at least FIG. 4. The matrix material may include nanoparticles, such as metallic nanoparticles, embedded in a glass material. The description of ceramic structures, matrix materials, glass materials, and nanoparticles provided with respect to FIG. 4 is generally applicable herein and is not repeated here.

In some cases, a ceramic structure of the composite enclosure component 1310 extends over a substantial entirety of the composite enclosure component. For example, the ceramic structure may at least partially define side walls and a rear wall of the ceramic enclosure component. However, the ceramic structure and/or the matrix material may be configured to in order to provide additional reinforcement in one or more regions of the composite enclosure component, such as the corner region 1308. For example, the ceramic structure may be configured to have a lower porosity in a given region of the composite enclosure component in order to provide additional reinforcement in that region. As an additional example, a higher concentration of the metallic nanoparticles may be provided in a given region of the composite enclosure component in order to provide additional toughness to that region. In other cases, the ceramic structure may be provided only at specific positions of the composite enclosure component 1310.

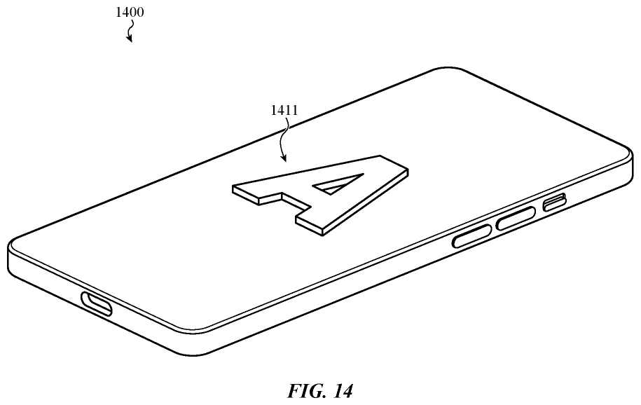

FIG. 14 shows a view of a device including another enclosure component. The composite component 1411 may be included in an enclosure for the electronic device 1400 but need not define multiple surfaces of the electronic device. Instead, the composite component 1411 may define a symbol that may be part of a logo for the electronic device 1400. The electronic device 1400 may be an example of any of the electronic devices described herein.

In embodiments, the composite enclosure component 1411 includes a ceramic structure at least partially embedded in a matrix material as previously discussed with respect to at least FIG. 4. The matrix material may include nanoparticles, such as metallic nanoparticles, embedded in a glass material. The description of ceramic structures, matrix materials, glass materials, and nanoparticles provided with respect to FIG. 4 is generally applicable herein and is not repeated here.

FIG. 15 shows a block diagram of a sample electronic device. The schematic representation depicted in FIG. 15 may correspond to the devices depicted in FIGS. 1A to 1B and 14 as described above. However, FIG. 15 may also more generally represent other types of electronic devices including a component comprising a composite material as described herein.

In embodiments, an electronic device 1500 may include sensors 1520 to provide information regarding configuration and/or orientation of the electronic device in order to control the output of the display. For example, a portion of the display 1508 may be turned off, disabled, or put in a low energy state when all or part of the viewable area of the display 1508 is blocked or substantially obscured. As another example, the display 1508 may be adapted to rotate the display of graphical output based on changes in orientation of the device 1500 (e.g., 90 degrees or 180 degrees) in response to the device 1500 being rotated.

The electronic device 1500 also includes a processor 1506 operably connected with a computer-readable memory 1502. The processor 1506 may be operatively connected to the memory 1502 component via an electronic bus or bridge. The processor 1506 may be implemented as one or more computer processors or microcontrollers configured to perform operations in response to computer-readable instructions. The processor 1506 may include a central processing unit (CPU) of the device 1500. Additionally, and/or alternatively, the processor 1506 may include other electronic circuitry within the device 1500 including application specific integrated chips (ASIC) and other microcontroller devices. The processor 1506 may be configured to perform functionality described in the examples above.

The memory 1502 may include a variety of types of non-transitory computer-readable storage media, including, for example, read access memory (RAM), read-only memory (ROM), erasable programmable memory (e.g., EPROM and EEPROM), or flash memory. The memory 1502 is configured to store computer-readable instructions, sensor values, and other persistent software elements.

The electronic device 1500 may include control circuitry 1510. The control circuitry 1510 may be implemented in a single control unit and not necessarily as distinct electrical circuit elements. As used herein, “control unit” will be used synonymously with “control circuitry.” The control circuitry 1510 may receive signals from the processor 1506 or from other elements of the electronic device 1500.

As shown in FIG. 15, the electronic device 1500 includes a battery 1514 that is configured to provide electrical power to the components of the electronic device 1500. The battery 1514 may include one or more power storage cells that are linked together to provide an internal supply of electrical power. The battery 1514 may be operatively coupled to power management circuitry that is configured to provide appropriate voltage and power levels for individual components or groups of components within the electronic device 1500. The battery 1514, via power management circuitry, may be configured to receive power from an external source, such as an alternating current power outlet. The battery 1514 may store received power so that the electronic device 1500 may operate without connection to an external power source for an extended period of time, which may range from several hours to several days.

In some embodiments, the electronic device 1500 includes one or more input devices 1518. The input device 1518 is a device that is configured to receive input from a user or the environment. The input device 1518 may include, for example, a push button, a touch-activated button, a capacitive touch sensor, a touch screen (e.g., a touch-sensitive display or a force-sensitive display), a capacitive touch button, dial, crown, or the like. In some embodiments, the input device 1518 may provide a dedicated or primary function, including, for example, a power button, volume buttons, home buttons, scroll wheels, and camera buttons.

The device 1500 may also include one or more sensors or sensor modules 1520, such as a force sensor, a capacitive sensor, an accelerometer, a barometer, a gyroscope, a proximity sensor, a light sensor, or the like. In some cases, the device 1500 includes a sensor array (also referred to as a sensing array) which includes multiple sensors 1520. For example, a sensor array associated with a protruding feature of a cover member may include an ambient light sensor, a Lidar sensor, and a microphone. In some cases, one or more camera modules may also be associated with the protruding feature. The sensors 1520 may be operably coupled to processing circuitry. In some embodiments, the sensors 1520 may detect deformation and/or changes in configuration of the electronic device and be operably coupled to processing circuitry that controls the display based on the sensor signals. In some implementations, output from the sensors 1520 is used to reconfigure the display output to correspond to an orientation or folded/unfolded configuration or state of the device. Example sensors 1520 for this purpose include accelerometers, gyroscopes, magnetometers, and other similar types of position/orientation sensing devices. In addition, the sensors 1520 may include a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing device.

In some embodiments, the electronic device 1500 includes one or more output devices 1504 configured to provide output to a user. The output device 1504 may include a display 1508 that renders visual information generated by the processor 1506. The output device 1504 may also include one or more speakers to provide audio output. The output device 1504 may also include one or more haptic devices that are configured to produce a haptic or tactile output along an exterior surface of the device 1500.

The display 1508 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 1508 is a liquid-crystal display or an electrophoretic ink display, the display 1508 may also include a backlight component that can be controlled to provide variable levels of display brightness. If the display 1508 is an organic light-emitting diode or an organic electroluminescent-type display, the brightness of the display 1508 may be controlled by modifying the electrical signals that are provided to display elements. In addition, information regarding configuration and/or orientation of the electronic device may be used to control the output of the display as described with respect to input devices 1518. In some cases, the display is integrated with a touch and/or force sensor in order to detect touches and/or forces applied along an exterior surface of the device 1500.

The electronic device 1500 may also include a communication port 1512 that is configured to transmit and/or receive signals or electrical communication from an external or separate device. The communication port 1512 may be configured to couple to an external device via a cable, adaptor, or other type of electrical connector. In some embodiments, the communication port 1512 may be used to couple the electronic device 1500 to a host computer.

The electronic device 1500 may also include at least one accessory 1516, such as a camera, a flash for the camera, or other such device. The camera may be part of a camera array or sensing array that may be connected to other parts of the electronic device 1500 such as the control circuitry 1510.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As referred to herein, a composition that is substantially free of one or more elements or compounds may contain only an incidental amount of the element or compound. In some examples, the composition may include less than 0.1 at % of the element or compound.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A portable electronic device, comprising:
a touch-sensitive display; and
an enclosure at least partially surrounding the touch-sensitive display and comprising:
a front cover assembly positioned over the touch-sensitive display; and
a housing assembly coupled to the front cover assembly, the housing assembly including an enclosure component formed from a composite material comprising:
a ceramic lattice structure defining a pore network;
a matrix formed from a glass material and at least partially filling pores of the pore network; and
a set of metallic nanoparticles embedded in the glass material.

2. The portable electronic device of claim 1, wherein:
the portable electronic device further comprises an antenna assembly;
the antenna assembly is positioned within the housing assembly;
the antenna assembly is configured to receive a radio-frequency signal from an external source through the composite material of the enclosure component; and
the composite material has a dielectric constant ranging from 4 to 10.

3. The portable electronic device of claim 2, wherein:
the set of metallic nanoparticles is a first set of metallic nanoparticles distributed in a first portion of the matrix and having a first light absorption in the visible spectrum; and
the composite material further comprises a second set of metallic nanoparticles distributed in a second portion of the matrix and having a second light absorption, different from the first light absorption, in the visible spectrum.

4. The portable electronic device of claim 3, wherein:
the first portion of the matrix is positioned in a first pore of the pore network and defines a first portion of an exterior surface of the enclosure component; and
the second portion of the matrix is positioned in a second pore that is adjacent to the first pore, the second portion of the matrix defining a second portion of the exterior surface of the enclosure component.

5. The portable electronic device of claim 4, wherein each of the first and the second sets of metallic nanoparticles have a median size ranging from 15 nm to 150 nm.

6. The portable electronic device of claim 1, wherein the composite material comprises from 20 percent to 60 percent by volume of the ceramic lattice structure.

7. The portable electronic device of claim 1, wherein the ceramic lattice structure is formed from a zirconia-based material.

8. An electronic watch comprising:
a display;
a rear-facing sensing array; and
an enclosure comprising:
a composite housing component defining a side surface and a portion of a rear surface of the electronic watch, the composite housing component comprising:
a ceramic network defining a plurality of pores;
a glass material extending into at least some of the plurality of pores and defining at least a portion of an exterior surface of the enclosure; and
a set of metallic nanoparticles within the glass material; and
a front cover assembly coupled to the composite housing component and positioned over the display.

9. The electronic watch of claim 8, further comprising a wireless charging assembly, wherein the wireless charging assembly is configured to receive wireless power from an external power source through the portion of the rear surface of the electronic watch.

10. The electronic watch of claim 9, wherein the enclosure further comprises a rear cover assembly coupled to the composite housing component and positioned over the rear-facing sensing array.

11. The electronic watch of claim 9, wherein at least some of the pores of the plurality of pores define openings at the exterior surface of the enclosure.

12. The electronic watch of claim 11, wherein at least some of the openings have a size in a range from 100 micrometers to 2 millimeters.

13. The electronic watch of claim 11, wherein the openings at the exterior surface are substantially filled by the glass material and the set of metallic nanoparticles.

14. The electronic watch of claim 11, wherein:
a concentration of metallic nanoparticles defined by the set of metallic nanoparticles varies along an external surface region of the composite housing component; and
the variation in the concentration of metallic nanoparticles along the external surface region produces a chromatic color variation along the exterior surface of the composite housing component.

15. A portable electronic device comprising:
an enclosure at least partially defining an internal cavity of the portable electronic device, the enclosure comprising:
a first enclosure component including a composite material comprising:
a porous ceramic structure defining surface pores along an exterior surface of the portable electronic device;
a glass material filling the surface pores of the porous ceramic structure; and
a set of metallic nanoparticles embedded within the glass material and having a concentration that varies along a thickness direction of the first enclosure component; and
a second enclosure component coupled to the first enclosure component.

16. The portable electronic device of claim 15, further comprising a radio-frequency component, wherein:
the radio-frequency component is positioned within the internal cavity and configured to transmit a wireless signal through the composite material; and
the porous ceramic structure is formed of a ceramic material having a dielectric constant ranging from 5 to 20.

17. The portable electronic device of claim 15, further comprising a display, wherein:
the first enclosure component defines a side surface and a rear surface of the portable electronic device; and
the second enclosure component defines a transparent window region positioned over the display.

18. The portable electronic device of claim 17, wherein:
the first enclosure component defines a corner region; and
the composite material is located in the corner region.

19. The portable electronic device of claim 17, further comprising a rear-facing sensing array, wherein:
the transparent window region defined by the second enclosure component is a first transparent window region; and
the first enclosure component defines a second transparent window region over the rear-facing sensing array.

20. The portable electronic device of claim 19, wherein the transparent window region is substantially free of the metallic nanoparticles.
